(19) United States
(12) Patent Application Publication
(10) Pub. No.: US 2005/0163154 A1
(43) Pub. Date: Jul. 28, 2005

(54) Communication method and communication system

(75) Inventor: Masao Matsuda, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/041,408

(22) Filed: Jan. 25, 2005

Related U.S. Application Data
(63) Continuation of application No. PCT/JP02/08994, filed on Sep. 4, 2002.

(51) Int. Cl. H04L 12/66

(52) U.S. Cl. 370/463

(57) ABSTRACT

A communication method using first and second different transmission speeds in an upstream communications line from user's premises to a central office and a downstream communications line from the central office to the user's premises, respectively, is disclosed. The communication method includes the steps of (a) calculating bandwidth employable for the upstream and downstream communications lines; and (b) allocating the bandwidth between the upstream and downstream communications lines so that the ratio of the first transmission speed to the second transmission speed is set to a certain value.

### CROSS REFERENCE TO RELATED APPLICATION

This application is a U.S. continuation application filed under 35 U.S.C. 111(a) claiming benefit under 35 U.S.C. 120 and 365(c) of PCT International Application No. PCT/JP2002/008994, filed Sep. 4, 2002, the entire contents of which are hereby incorporated by reference.

### BACKGROUND OF THE INVENTION

1. Field of the Invention

The present invention generally relates to ADSL (Asymmetric Digital Subscriber Line) communication methods and communication systems, and more particularly to an ADSL communication method and communication system that employ DMT (Discrete Multi-Tone) modulation which enable high-speed downstream transmission of a large amount of data.

2. Description of the Related Art

An increasing demand for digital communications such as the Internet has required faster interconnection lines between users and telecommunications carriers. In order to meet this requirement, ADSL communication systems that enable high-speed transmission using existing metal cables have been used.

According to the ADSL communication method, the data transmission speed of the downlink from a carrier to a user is set to be higher than that of the uplink from the user to the carrier, so that a large amount of data can be transmitted downstream at high speed. ADSL is optimum for the Internet, which generates a large amount of downstream traffic.

FIG. 1 is a schematic diagram illustrating a connection configuration of an ADSL network 100 using an ADSL modem. The ADSL network 100 includes user (customer) premises equipment 110, exchange office (central office) equipment 120, and an existing telephone line 130 connecting the user's (customer's) premises and the exchange office (central office). The user premises equipment 110 includes a POTS (Plain Old Telephone Service) splitter 111, an existing telephone 112, an ADSL modem (ATU-R) 113, and a terminal 114 transmitting and receiving data. The POTS splitter 111 separates a signal of a low frequency band of approximately 4 kHz used for the conventional voice telephone and a signal of a high frequency band used by ADSL modems for data communications. The exchange office equipment 120 includes an MDF (Main Distributing Frame) 121, a POTS splitter 122, an existing switching device 133, and a DSLAM (Digital Subscriber Line Access Multiplexer) 134. The MDF 121 is a distributing frame installed in a location where lines coming from outside first enter a building. The DSLAM 134 is an ADSL device (ATU-C). The existing switching device 133 is further connected to a public telephone network 135. The DSLAM 134 is connected to the Internet 136. The existing telephone line 130 establishes a connection between the POTS splitter 111 of the user premises equipment 110 and the MDF 121 of the exchange office equipment 120.

The ADSL communication system mainly employs two types of modulation methods: CAP (Carrierless Amplitude and Phase) modulation and DMT modulation.

The CAP modulation performs QAM (Quadrature Amplitude Modulation) using one carrier frequency for each of upstream and downstream signals.

On the other hand, the DMT modulation is one type of multi-carrier modulation, which transmits data by distributing the data to 250 carrier waves (subcarriers). DMT technology is described in detail in Takashi Tsutsui; ADSL, pp. 119-161, Kobosha, JAPAN (1998). The DMT modem is specified by ANSI (American National Standards Institute).

A description is given below of an ADSL communication system employing the DMT modulation of the above-mentioned two modulation methods.

FIG. 2 is a diagram illustrating the disposition of the transmission spectrums of both upstream and downstream transmitted signals. In FIG. 2, POTS indicates a signal of a low frequency band of approximately 4 kHz used for the conventional telephone voice as described above. The 250 subcarriers employed in the DMT modulation are indicated by #6 through #255. The subcarrier indicated by #6 is a subcarrier of the lowest frequency, and the subcarrier indicated by #255 is a subcarrier of the highest frequency. According to the ANSI and ITU-T (International Telecommunication Union-the Telecommunication Standardization Sector) recommendations, the frequencies of the subcarriers are spaced at intervals of 4.3125 kHz. Each subcarrier can transmit 4000 symbols per second. The 26 subcarriers #6 through #31 are statically assigned for use in the upstream data transmission from a user to a carrier, and the 224 subcarriers #32 through #225 are statically assigned for use in the downstream data transmission from the carrier to the user. Accordingly, in the case of assigning 8- bit data transmission to each symbol (that is, each subcarrier), for instance, the maximum upstream data transmission rate (speed) is 4000 (symbols per second)×8 (bits)×26=832 Kbps, and the maximum downstream data transmission rate (speed) is 4000 (symbols per second)×8 (bits)×224=7.168 Mbps.

The subcarriers of an ADSL communication system employing the DMT modulation are provided in a relatively high frequency band of approximately 30 kHz to 1104 kHz. Accordingly, if the length of the telephone line 130 or the distance between the exchange office in which the DSLAM 134 is installed and the user's premises in which the ADSL modem 113 is installed shown in FIG. 1 increases, a signal transmitted through the telephone line 130 is attenuated significantly. With respect to this problem, the number of subcarriers actually assigned to information transmission is reduced or the number of bits assigned to a subcarrier is reduced so that stable communications can be performed.

However, the attenuation of the transmitted signal due to an increase in the line length of the telephone line 130 increases as the subcarrier frequency becomes higher. Accordingly, the subcarriers become unusable in order from that of a greater number, that is, #255 in this case, to those of lower frequencies. For instance, in the case of a line length of several kilometers, the upstream transmission speed using the subcarriers on the low frequency side hardly decreases because almost all assigned subcarriers can be used. On the other hand, the downstream transmission speed may decrease extremely because the subcarriers on the high frequency side are prevented from being used.

In this case, the downstream transmission speed may become lower than the upstream transmission speed.

As described above, the ADSL communication system is a technology that has been developed for an application that requires an overwhelmingly larger amount of information to be transmitted downstream than upstream, such as an application for distributing video through the Internet. Accordingly, it is required to increase the downstream transmission speed as much as possible.

Japanese Laid-Open Patent Application No. 11-275220 discloses a variable asymmetric subscriber line transmission system that reduces data transfer time and response time. Published Japanese Translation of PCT International Application No. 2002-504283 discloses adaptive bit allocation for variable bandwidth multicarrier communication. Published Japanese Translation of PCT International Application No. 2001-523931 discloses an adaptive time division duplexing method for dynamic bandwidth allocation within a wireless communication system.

However, there has been no consideration of increasing the downstream transmission speed as much as possible by dynamically allocating bandwidth between the upstream side and the downstream side at a certain ratio when the downstream transmission speed becomes lower than the upstream transmission speed in the ADSL communication system employing the DMT modulation.

### SUMMARY OF THE INVENTION

Accordingly, it is a general object of the present invention to provide a communication method and a communication system in which the above- described disadvantage is eliminated.

A more specific object of the present invention is to provide a communication method and a communication system suitably applicable to the Internet by dynamically allocating communications bandwidth between the upstream side and the downstream side at a certain ratio, the communications bandwidth being composed of low-attenuation subcarriers of the DMT modulation employable for communications.

The above objects of the present invention are achieved by a communication method using a first transmission speed in an upstream communications line from user's premises to a central office and a second transmission speed in a downstream communications line from the central office to the user's premises, the first transmission speed being different from the second transmission speed, the communication method including the steps of: (a) calculating bandwidth employable for the upstream and downstream communications lines; and (b) allocating the bandwidth between the upstream and downstream communications lines so that a ratio of the first transmission speed to the second transmission speed is set to a certain value.

The above objects of the present invention are also achieved by a communication system using a first transmission speed in an upstream communications line from user's premises to a central office and a second transmission speed in a downstream communications line from the central office to the user's premises, the first transmission speed being different from the second transmission speed, the communication system including: a calculation part configured to calculate bandwidth employable for the upstream and downstream communications lines; and an allocation part configured to allocate the bandwidth between the upstream and downstream communications lines so that a ratio of the first transmission speed to the second transmission speed is set to a certain value.

The above objects of the present invention are also achieved by a transceiver performing data communications by a communication method using a first transmission speed in an upstream communications line from user's premises to a central office and a second transmission speed in a downstream communications line from the central office to the user's premises, the first transmission speed being different from the second transmission speed, the transceiver including: a calculation part configured to calculate bandwidth employable for the upstream and downstream communications lines; and an allocation part configured to allocate the bandwidth between the upstream and downstream communications lines so that a ratio of the first transmission speed to the second transmission speed is set to a certain value.

The above objects of the present invention are also achieved by an ADSL modem performing data communications by a communication method using a first transmission speed in an upstream communications line from user's premises to a central office and a second transmission speed in a downstream communications line from the central office to the user's premises, the first transmission speed being different from the second transmission speed, the ADSL modem including: a calculation part configured to calculate bandwidth employable for the upstream and downstream communications lines; and an allocation part configured to allocate the bandwidth between the upstream and downstream communications lines so that a ratio of the first transmission speed to the second transmission speed is set to a certain value.

According to the present invention, the bandwidth composed of low-attenuation subcarriers of the DMT modulation employable for communications can be allocated dynamically between the upstream side and the downstream side at a certain ratio. Accordingly, it is possible to increase the downstream transmission speed as much as possible.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram illustrating a connection configuration of an ADSL network;

FIG. 2 is a diagram illustrating the transmission spectrum disposition of the DMT modulation;

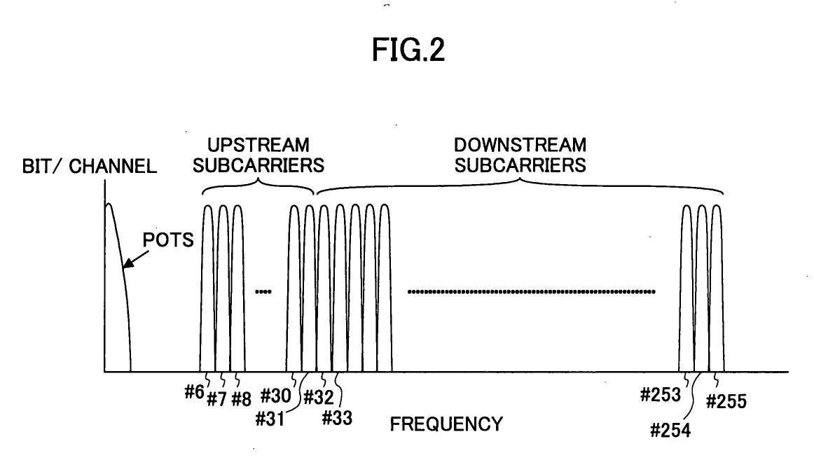

FIG. 3 is a flowchart illustrating a simplified sequence of initialization performed when an ADSL device (ATU-C) in an exchange office and an ADSL modem (ATU-R) in user's premises establishes a line connection according to an embodiment of the present invention;

FIG. 4 is a diagram illustrating a flow of handshaking of the ATU-C and the ATU-R according to the embodiment of the present invention;

FIG. 5 is a timing diagram illustrating transceiver training of the ATU-C and the ATU-R according to the embodiment of the present invention;

FIG. 6 is a diagram illustrating assigned subcarriers according to the embodiment of the present invention;

FIG. 7 is a diagram illustrating the principles of the DMT modulation; and

FIG. 8 is a schematic block diagram illustrating a transceiver for implementing the present invention according to the embodiment of the present invention.

### DETAILED DESCRIPTION OF THE PREFERRED EMBODIMENTS

A description is given below, with reference to the accompanying drawings, of an embodiment of the present invention.

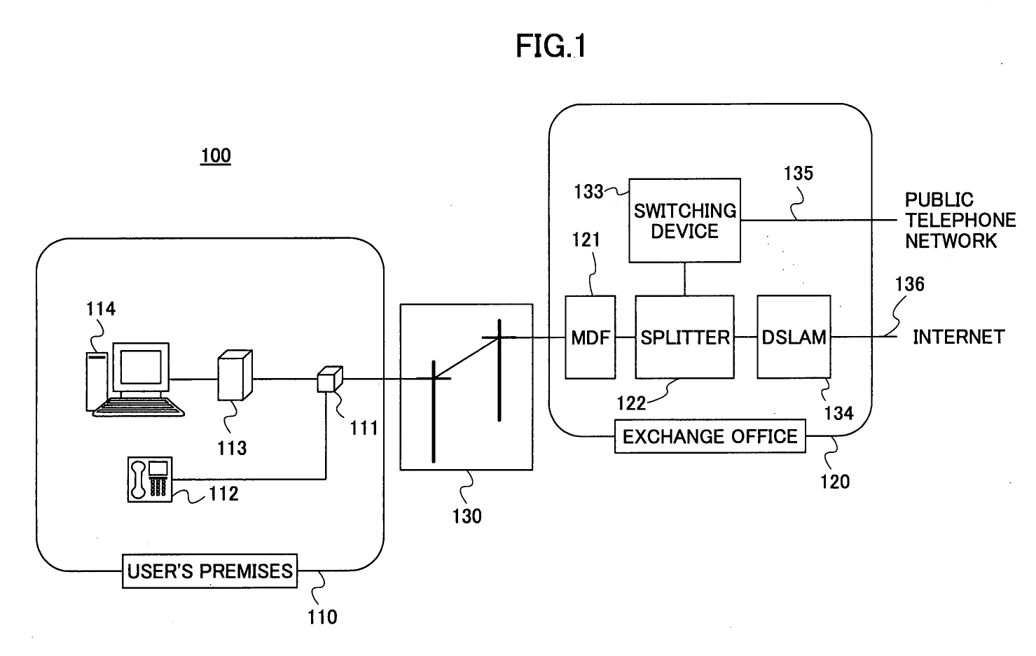

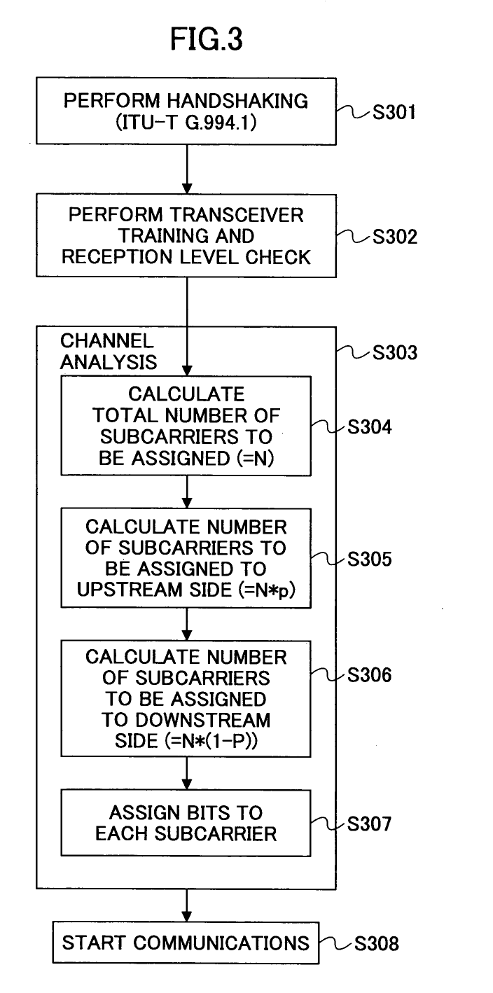

FIG. 3 is a flowchart illustrating a simplified sequence of initialization performed when the DSLAM 134 (FIG. 1), which is an ADSL device (ATU-C) in the exchange (central) office, and the ADSL modem 113 (ATU-R) (FIG. 1) in the user's premises establish a line connection. In channel analysis in this initialization sequence, the DSLAM 134 (hereinafter also referred to as “ATU-C 134”) in the exchange office and the ADSL modem 113 (hereinafter also referred to as “ATU-R 113”) in the user's premises check the reception level of each subcarrier, thereby determining assignable subcarriers.

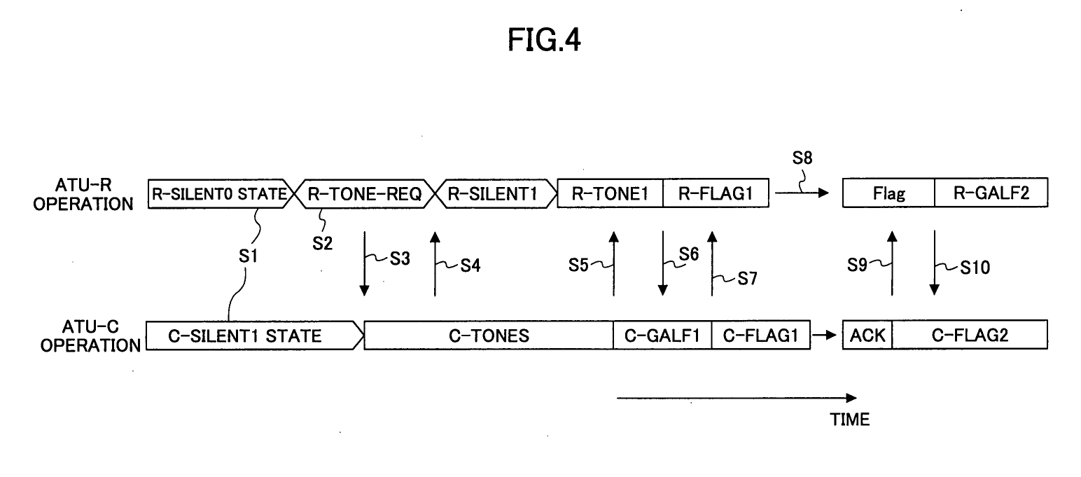

First, in step S301 of FIG. 3, handshaking is performed between the DSLAM (ATU-C) 134 and the ADSL modem (ATU-R) 113. FIG. 4 is a diagram illustrating a flow of handshaking. ITU-T Recommendation G.994.1 Handshake procedures for Digital Subscriber Line (DSL) transceivers is referred to for the details of a handshake procedure.

First, in step S1 of FIG. 4, it is assumed that the ATU-R 113 is in the state R-SILENT0 and the ATU-C 134 is in the state C-SILENT1.

Next, in step S2, the ATU-R 113 transmits a tone (for instance, of 30.1875 kHz or 38.8125 kHz) to the ATU-C 134 as R-TONE-REQ.

Next, in step S3, when the ATU-C 134 detects the tone of step S2, the ATU-C 134 transmits a tone C-TONES (for instance, of 51.75 kHz, 60.375 kHz, or 276.0 kHz) to the ATU-R 113 to show that the tone of step S2 has been detected.

Next, in step S4, when the ATU-R 113 detects the tone of step S3, the ATU-R 113 stops transmitting R-TONE-REQ, and after a certain period of time (R-SILENT1), the ATU-R 113 transmits R-TONE1 (for instance, 30.1875 kHz or 38.8125 kHz) to the ATU-C 134.

Then, in step S5, when the ATU-C 134 detects R-TONE1, the ATU-C 134 transmits C-GALF1 to the ATU-R 113 to notify the ATU-R 113 of the detection of R-TONE1.

Next, in step S6, when the ATU-R 113 detects C-GALF1, the ATU-R 113 transmits R-FLAG1 to the ATU-C 134 to notify the ATU-C 134 of the detection of C-GALF1.

Then, in step S7, when the ATU-C 134 detects R-FLAG1, the ATU-C 134 transmits C-FLAG1 to the ATU-R 113.

Next, in step S8, when the ATU-R 113 detects C-FLAG1, the transaction state of the next step is entered. In the transaction state, the ATU- R 113 transmits a mode (ITU-T Recommendation G.992.1 or G.992.2, Annex A or Annex C), characteristics, and capability (such as net data rate) to the ATU-C 134.

Then, in step S9, the ATU-C 134 transmits ACK to the ATU-R 113.

Finally, in step S10, when the ATU-R 113 detects ACK, the ATU-R 113 transmits R-GALF2 to the ATU-C 134 to end the handshaking. As a result, a handshake is established between the ATU-C 134 and the ATU-R 113.

Next, the ATU-C 134 and the ATU-R 113 proceed to step S302 of FIG. 3, which is a step of transceiver training.

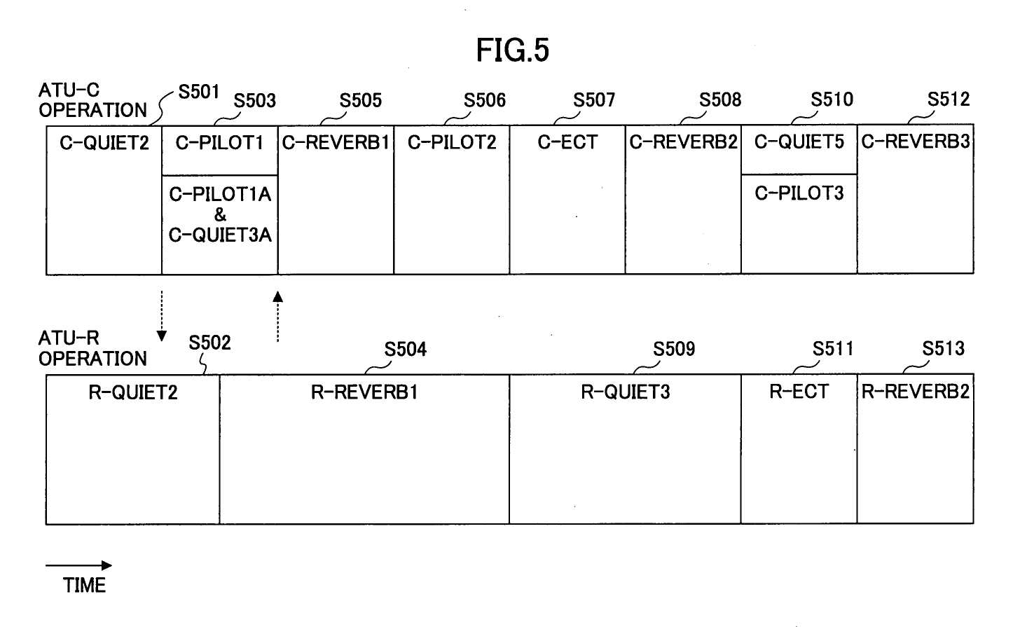

FIG. 5 is a timing diagram illustrating transceiver training.

C-QUIET2 of step S501 of the ATU-C 134 indicates the state after the above-described handshaking. R-QUIET2 of step S502 of the ATU-R 113 also indicates the state after the above-described handshaking.

Next, during the C-PILOT1 period of step S503, the ATU-C 134 measures the upstream output level of the subcarriers #7-18 of R-REVERB1 of step S504, and calculates a downstream PSD (Power Spectral Density). The same operation as in the C-PILOT1 period of step S503 is performed in the C-PILOT1A period of step S503. When the ATU-C 134 detects the first symbol of R-REVERB1 of step S504, the ATU-C 134 starts a timer and proceeds to C-QUIET3A of step S503.

Next, in the C-QUIET3A period of step S503, the ATU-C 134 detects C-PILOT1 from R-REVERB1 of step S504 transmitted from the ATU-R 113, and makes a response.

Next, in the R-REVERB1 period of step S504, the ATU-R 113 measures upstream wideband power in order to adjust the transmission power level of the ATU-C 134, and adjusts the gain control of its receiver.

Then, in the C-REVERB1 period of step S505, the automatic gain control (AGC) of each of the receivers of the ATU-C 134 and the ATU-R 113 is adjusted to an appropriate level.

In the C-PILOT2 period of step S506, the same operation as in the C-PILOT1 period is performed.

Next, in the C-ECT period of step S507, an echo canceller at the ATU-C 134 is trained.

In the C-REVERB2 period of step S508, the receiver of the ATU-R 113 performs synchronization and trains a receiver equalizer.

In the R-QUIET3 period of step S509 and the C-QUIET5 period of step S510, a pause is made.

In the C-PILOT3 period of step S510, the same operation as in the C-PILOT1 period of step S503 is performed.

In the R-ECT period of step S511, an echo canceller at the ATU-R 113 is trained.

In the C-REVERB3 period of step S512, the receiver of the ATU-R 113 performs synchronization and trains the receiver equalizer.

In the R-REVERB2 period of step S513, the receiver of the ATU-C 134 performs synchronization and trains a receiver equalizer.

By the above-described steps, the downstream PSD is calculated, the gain control of the receivers of the ATU-C 134 and the ATU-R 113 is performed, and the echo cancellers are trained in the training period.

In the above-described transceiver training steps of FIG. 5, the ATU-C 134 and the ATU-R 113 measure the reception level of each subcarrier during the C-PILOT1 period of step S503, the R- REVERB1 period of step S504, and the C-REVERB1 period of step S505.

Next, step S303 of FIG. 3, which is a step of channel analysis, is entered. In this channel analysis step, the number of subcarriers assigned to each of the upstream side and the downstream side is determined.

In step S303 of channel analysis, subcarriers employable for data transmission are selected based on the reception level of each subcarrier measured in the above-described transceiver training step (step S302). This is performed by selecting subcarriers whose attenuation as a result of being transmitted through the telephone line 130 of FIG. 1 is less than a certain level. Then, the number of subcarriers to be assigned to the upstream side and the number of subcarriers to be assigned to the downstream side is determined at a certain ratio from the total number of assignable (employable) subcarriers. The determined number of upstream-side subcarriers and that of downstream-side subcarriers are transmitted from the ATU-C 134 to the ATU-R 113 as a message.

Next, a description is given of the operation of step S303 of channel analysis.

First, in sub-step S304, the total number of subcarriers employable for data transmission is calculated as N.

Next, in sub-step S305, the number of subcarriers to be assigned to the upstream side is calculated by N*p, where p is the ratio of bandwidth allocation between the upstream side and the downstream side.

Next, in sub-step S306, the number of subcarriers to be assigned to the downstream side is calculated by N*(1−p).

Then, in sub-step S307, the bits of data to be transmitted are assigned to each subcarrier.

Finally, in step S308, communications are started.

For instance, it is assumed that the subcarriers #6 through #120 (N=115) are selected as employable for data transmission based on the reception level of each subcarrier measured in the above-described training step (step S302). In this case, since the 224 subcarriers #32 through #255 are statically assigned for use in downstream data transmission according to the conventional technique, the subcarriers #121 through #255 do not contribute to the actual data transmission although being assigned to the downstream side. Therefore, according to the present invention, when the subcarriers #6 through #120 are employable for data transmission, the number of subcarriers to be assigned for use in the upstream data transmission from the ATU-R 113 to the ATU-C 134 is determined as 12 by rounding up 11.5=(120-6+1)×0.1 (p=0.1), and the number of subcarriers to be assigned for use in the downstream data transmission from the ATU-C 134 to the ATU-R 113 is determined as 103=(120−6+1)−12. In this case, the upstream-downstream ratio is 1:10.

When those numbers are converted to transmission speed, the upstream data transmission speed is 4000×8×12 =384 kbps, and the downstream data transmission speed is 4000×8×103−3.296 Mbps. In this embodiment, p=0.1, but other values may also be employed as p.

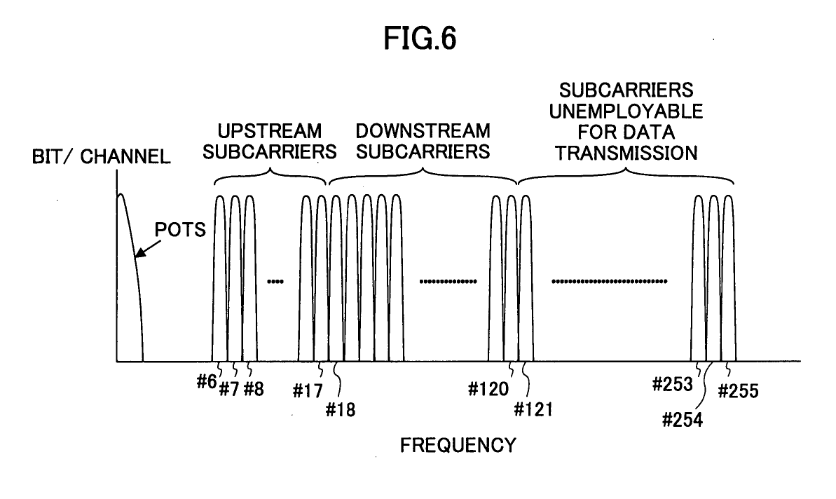

FIG. 6 is a diagram illustrating the subcarriers assigned as described above according to the present invention. Referring to FIG. 6, the subcarriers #6 through #17 are assigned to the upstream communications line, and the subcarriers #18 through #120 are assigned to the downstream communications line. The subcarriers #121 through #255, which are determined as unemployable for data transmission by the measurement of the reception level of each subcarrier during the above-described transceiver training, are assigned to neither the upstream communications line nor the downstream communications line.

On the other hand, according to the conventional technique that statically assigns the 26 subcarriers #6 through #31 for use in the upstream data transmission from a user to a carrier and the 224 subcarriers #32 through #255 for use in the downstream data transmission from the carrier to the user, the upstream data transmission speed is 4000×8×26 =832 kbps, and the downstream data transmission speed is 4000×8×(120−6+1−26)=2.848 Mbps. This shows that the downstream data transmission rate can be higher by 448 kbps by the subcarrier assignment according to the present invention.

Thus, the transmission speed of the downstream communications line can be increased as much as possible by employing only subcarriers that are determined as employable for data transmission as a result of the measurement of the reception level of each subcarrier during transceiver training before data communications, and dynamically assigning the employable subcarriers to the upstream communications line and the downstream communications line at a certain ratio.

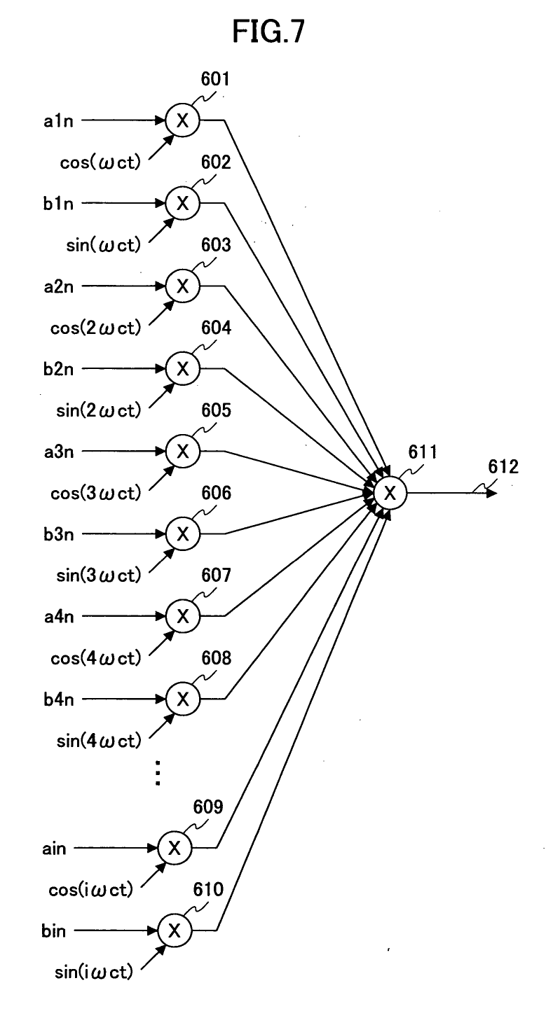

FIG. 7 is a diagram illustrating the principles of the DMT modulation. In FIG. 7, cos (ωct), sin (ωct), cos (2ωct), sin (2ωct), . . . , cos(iωct), sin(iωct) indicate subcarriers, and the assignment numbers of the subcarriers are 1, 2, 3, 4, . . . i. Further, a1n, b1n, . . . , ain, bin indicate input data, and reference numerals 601 through 610 indicate multipliers. The multipliers 601, 603, . . . , 609 of odd-numbered reference numerals multiply the input data ain by the subcarrier cos(iωct). The multipliers 602, 604, . . . , 610 of even-numbered reference numerals multiply the input data bin by the subcarrier sin(iωct). An adder 611 adds up the outputs of the multipliers 601 through 610, thereby outputting a DMT modulation signal 612. The variables of the internal control circuits of the DSLAM (ATU-C) 134 in the exchange (central) office and the ADSL modem (ATU-R) 113 of the user's premises are set according to the present invention so that the agreement of the numbers of the assigned upstream-side and downstream-side subcarriers obtained as a result of the channel analysis is established between the DSLAM (ATU-C) 134 and the ADSL modem (ATU-R) 113. As a result, the subcarriers to be assigned to the input data ain and bin are determined, so that intercommunications can be performed using a newly allocated frequency band.

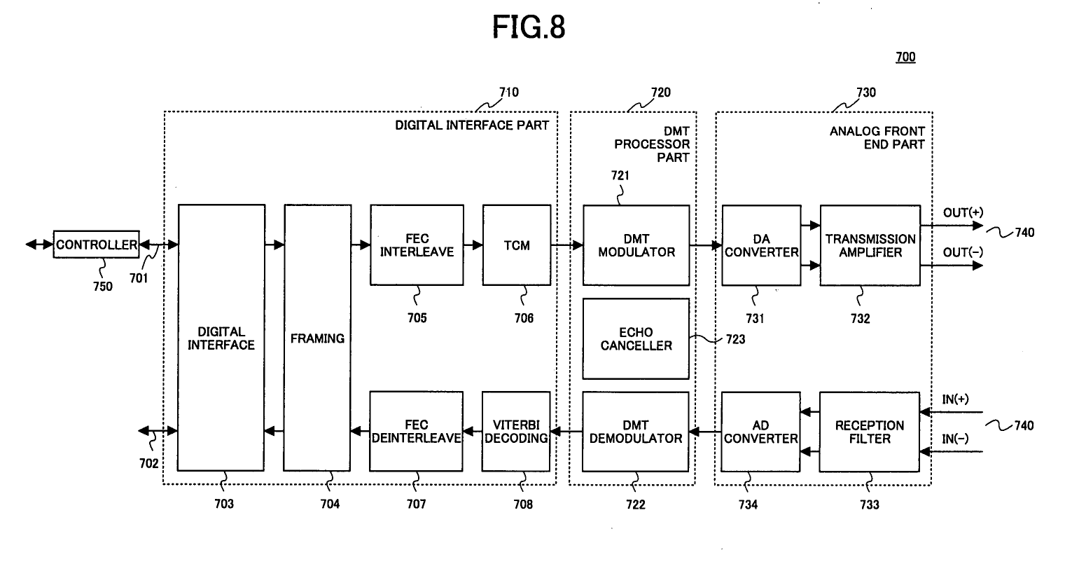

FIG. 8 is a schematic block diagram illustrating a transceiver 700 of, for instance, the ATU-C 134 for implementing the present invention. The transceiver 700 includes a digital interface part 710, a DMT processor part 720, an analog front end part 730, and a controller 750. The digital interface part 710 includes a digital interface 703, a framing part 704, an FEC interleave part 705, a TCM (Time Compression Multiplexing) part 706, an FEC deinterleave part 707, and a Viterbi decoding part 708. The digital interface 703 includes a digital port 701 and a connection port 702 to an interleaver memory.

The DMT processor part 720 includes a DMT modulator 721, a DMT demodulator 722, and an echo canceller 723.

The analog front end part 730 includes a DA (digital-to-analog) converter 731, a transmission amplifier 732, a reception filter 733, and an AD (analog-to-digital) converter 734.

Data input from the digital port 701 to the digital interface 703 by the controller 750 is configured into a frame by the framing part 704, and is subjected to interleaving and error-correction coding by the FEC interleave part 705. The data is then sent to the DMT modulator 721 through the TCM part 706. The data input to the DMT modulator 721 is subjected to inverse Fourier transform, and is sent to the DA converter 731. Then, the data is sent out to a transmission line 740 by the transmission amplifier 732.

On the other hand, a signal input from the transmission line 740 is sent through the reception filter 733 to the AD converter 734, where the signal is converted into a digital signal. The digital signal obtained in the AD converter 734 is subjected to Fourier transform by the DMT demodulator 722 to be sent to the Viterbi decoding part 708. After being subjected to Viterbi decoding in the Viterbi decoding part 708, the signal is subjected to error correction and deinterleaving in the FEC deinterleave part 707. Data thus reproduced is deconfigured to input data, and is output to the digital port 701 through the digital interface 703.

The controller 750 receives signal reception levels output to the digital port 701 through the digital interface 703, and performs the processing for assigning subcarriers described above with reference to FIGS. 3 through 5. Then, the controller 750 sends the results of the subcarrier assignment to the digital interface 703 through the digital port 701, and sets each part of the transceiver 700 based on the subcarrier assignment results. Further, the subcarrier assignment results are transmitted to the ATU-R 113 through the digital interface part 710, the DMT processor part 720, and the analog front end part 730.

After the assignment of upstream-side and downstream-side subcarriers is thus determined, communications are started. A signal received through the reception filter 733 is output to the digital port 701 through the digital interface 703 to be output to a terminal through the controller 750.

The transceivers of the ATU-C 134 and the ATU-R 113 which transceivers performing processing for assigning subcarriers according to the present invention can be configured as described above.

The present invention is not limited to the specifically disclosed embodiment, and variations and modifications may be made without departing from the scope of the present invention.

1. A communication method using a first transmission speed in an upstream communications line from user's premises to a central office and a second transmission speed in a downstream communications line from the central office to the user's premises, the first transmission speed being different from the second transmission speed, the communication method comprising the steps of:
(a) calculating bandwidth employable for the upstream and downstream communications lines; and
(b) allocating the bandwidth between the upstream and downstream communications lines so that a ratio of the first transmission speed to the second transmission speed is set to a certain value.

2. The communication method as claimed in claim 1, wherein said step (a) calculates the bandwidth employable for the upstream and downstream communications lines based on a reception level of a signal detected during transceiver training.

3. The communication method as claimed in claim 2, wherein:
the communication method is an ADSL communication method using DMT modulation; and
the bandwidth is a total number of subcarriers employable for the upstream and downstream communications lines.

4. The communication method as claimed in claim 3, wherein said step (b) multiplies the total number of subcarriers employable for the upstream and downstream communications lines by a fixed value, and assigns the upstream communications line as many subcarriers as an integer greater than and closest to a result of the multiplication.

5. The communication method as claimed in claim 4, wherein said step (b) assigns the downstream communications line as many subcarriers as a number obtained by subtracting the number of the subcarriers assigned to the upstream communications line from the total number of subcarriers employable for the upstream and downstream communications lines.

6. The communication method as claimed in claim 1, wherein:
the communication method is an ADSL communication method using DMT modulation; and
the bandwidth is a total number of subcarriers employable for the upstream and downstream communications lines.

7. The communication method as claimed in claim 6, wherein said step (b) multiplies the total number of subcarriers employable for the upstream and downstream communications lines by a fixed value, and assigns the upstream communications line as many subcarriers as an integer greater than and closest to a result of the multiplication.

8. The communication method as claimed in claim 7, wherein said step (b) assigns the downstream communications line as many subcarriers as a number obtained by subtracting the number of the subcarriers assigned to the upstream communications line from the total number of subcarriers employable for the upstream and downstream communications lines.

9. A communication system using a first transmission speed in an upstream communications line from user's premises to a central office and a second transmission speed in a downstream communications line from the central office to the user's premises, the first transmission speed being different from the second transmission speed, the communication system comprising:
a calculation part configured to calculate bandwidth employable for the upstream and downstream communications lines; and
an allocation part configured to allocate the bandwidth between the upstream and downstream communications lines so that a ratio of the first transmission speed to the second transmission speed is set to a certain value.

10. A transceiver performing data communications by a communication method using a first transmission speed in an upstream communications line from user's premises to a central office and a second transmission speed in a downstream communications line from the central office to the user's premises, the first transmission speed being different from the second transmission speed, the transceiver comprising:
a calculation part configured to calculate bandwidth employable for the upstream and downstream communications lines; and
an allocation part configured to allocate the bandwidth between the upstream and downstream communications lines so that a ratio of the first transmission speed to the second transmission speed is set to a certain value.

11. The transceiver as claimed in claim 10, wherein:
the communication method is an ADSL communication method using DMT modulation;
the bandwidth is a total number of subcarriers employable for the upstream and downstream communications lines; and
the calculation part calculates the total number of subcarriers employable for the upstream and downstream communications lines based on a reception level of a signal detected during training of the transceiver.

12. The transceiver as claimed in claim 11, wherein the allocation part multiplies the total number of subcarriers employable for the upstream and downstream communications lines by a fixed value, and assigns the upstream communications line as many subcarriers as an integer greater than and closest to a result of the multiplication.

13. The transceiver as claimed in claim 12, wherein the allocation part assigns the downstream communications line as many subcarriers as a number obtained by subtracting the number of the subcarriers assigned to the upstream communications line from the total number of subcarriers employable for the upstream and downstream communications lines.

14. An ADSL modem performing data communications by a communication method using a first transmission speed in an upstream communications line from user's premises to a central office and a second transmission speed in a downstream communications line from the central office to the user's premises, the first transmission speed being different from the second transmission speed, the ADSL modem comprising:
a calculation part configured to calculate bandwidth employable for the upstream and downstream communications lines; and
an allocation part configured to allocate the bandwidth between the upstream and downstream communications lines so that a ratio of the first transmission speed to the second transmission speed is set to a certain value.
